(19) United States
(12) Patent Application Publication
(10) Pub. No.: US 2025/0147143 A1
(43) Pub. Date: May 8, 2025

(54) METHODS AND APPARATUS FOR HIERARCHICAL COOPERATIVE POSITIONING

(71) Applicant: Huawei Technologies Co., Ltd., Shenzhen (CN)

(72) Inventors: Ahmed Wagdy Abdelwahab Shaban, Kanata (CA); Alireza Bayesteh, Brossard (CA)

(21) Appl. No.: 19/003,812

(22) Filed: Dec. 27, 2024

Related U.S. Application Data
(63) Continuation of application No. PCT/CN2022/102877, filed on Jun. 30, 2022.

(51) Int. Cl. G01S 5/02; G01S 5/00

(52) U.S. Cl. CPC G01S 5/0289; G01S 5/0072

(57) ABSTRACT

Some embodiments of the present application provide for grouping of User Equipment (UEs) in clusters and/or tiers. The grouping may be based on a dynamically updated mean squared error-position/relative position map maintained at a transmission point. Additionally, grouping may be implemented in a hierarchical and cooperative manner, such that some UEs act, in a higher tier, as an Anchor UE to other UEs in lower tiers. Furthermore, the UEs may be understood to self-organize into clusters of UEs. A cluster of UEs may be represented by a single, representative UE to reduce signaling overhead between UEs in a given UE cluster and various Anchor UEs and/or transmission points. Moreover, cooperation between UEs in the same cluster may be based on sensing and on sharing, among the UEs, a relative position estimate and an position estimation MSE associated with the relative position estimate.

### CROSS-REFERENCE TO RELATED APPLICATIONS

This application is a continuation of International Application No. PCT/CN2022/102877, filed on Jun. 30, 2022, the disclosure of which is hereby incorporated by reference in its entirety.

### TECHNICAL FIELD

The present disclosure relates, generally, to positioning of devices and, in particular embodiments, to a hierarchical and cooperative approach to such positioning.

### BACKGROUND

Localization and positioning services are expected to have more significant roles in future wireless communication systems. In some known implementations, localization and positioning services are made available through evolved positioning techniques, such as New Radio Enhanced Cell ID (NR E-CID), Downlink Time Difference of Arrival (DL-TODA) and Uplink Time Difference of Arrival (UL-TODA). In some known implementations, localization and positioning services are made available through new-radio-specific positioning techniques, such as Uplink Angle of Arrival (UL-AOA), Downlink Angle of Departure (DL-AoD) and multi-cell Round Trip Time (multi-cell RRT). These conventional positioning techniques rely on a small number of fixed-location base stations or transmission points (TP), where the base stations (TPs) are required to cooperate. The base stations may cooperate either by sending positioning reference signals (PRS) or by receiving sounding reference signal (SRS), taking measurements of the corresponding reference signal and sending the measurements to a Location Management Function (LMF). The conventional positioning techniques mentioned up to this point may be shown to carry a significant disadvantage in that these conventional positioning techniques rely upon a small number of base stations or TPs with fixed locations to provide position information about a user. These conventional positioning techniques may be shown to suffer from a susceptibility to errors in the position estimates that may be traced to a non-line-of-sight (NLOS) bias. Such a bias may be shown to result in relatively large localization errors. The localization errors may be understood to be of a scale that is intolerable by some future applications and use cases. The conventional positioning techniques may also be shown to suffer from limited coverage due to small number of anchor points.

### SUMMARY

According to aspects of the present application, UEs may be dynamically grouped in clusters and/or tiers. The grouping may be based on a dynamically updated positioning mean squared error map maintained at a transmission point. Additionally, grouping may be implemented in a hierarchical and cooperative manner, such that some UEs act, in a higher tier, as an Anchor UE to other UEs in lower tiers. Furthermore, the UEs may be understood to self-organize into clusters of UEs. A cluster of UEs may be represented by a single, representative UE to reduce signaling overhead between UEs in a given UE cluster and various Anchor UEs and/or transmission points. Moreover, cooperation between UEs in the same cluster may be based on sensing and on sharing, among the UEs, a relative position estimate and a position estimation mean squared error (MSE) associated with the relative position estimate.

It may be shown that the main reason for NLOS-bias, and, consequently, position estimation errors, in conventional positioning techniques is that the conventional positioning techniques employ a line-of-sight (LOS) assumption in their calculations. Other reasons for NLOS-bias include a limited number of anchor points and a chance of NLOS that increases significantly in correspondence with increasing distance between anchor points and UEs. Many NLOS identification and/or mitigation methods have been developed to alleviate the effect of position estimation errors. However, these techniques may rely on signaling exchange between the network nodes and may require solving complicated, constrained optimization problems. Such solving may employ computationally intensive algorithms such as a maximum likelihood algorithm and a constrained weighted squares algorithm. Moreover, the computationally intensive algorithms use data obtained by sending more training signals to estimate the NLOS parameters for all UEs and their multi-paths. Thus, the computationally intensive algorithms may be shown to add complexity and signaling overhead to the conventional positioning techniques.

Aspects of the present application relate to positioning techniques that reduce or eliminate errors related to NLOS-bias, thereby providing effective positioning estimates suitable for future wireless communication systems.

A map of devices in an environment may be built based upon the provision, by the devices in the environment, of two-dimensional metrics so that a position on the map is a function of a position estimate and position estimation mean squared error estimate associated with the position estimate. This allows for classification of a given UE as either a Target UE or an Anchor UE or both. Additionally, the mean squared error estimate may be repeatedly improved upon until the mean squared error achieves a desired accuracy.

Cooperative positioning procedures disclosed herein include two different clustering techniques, namely, user-centric clustering and network-centric clustering. Conveniently, clustering may be shown to decrease the overhead of network signaling associated with high-precision positioning procedures.

Hierarchical positioning procedures disclosed herein utilize cooperation between UEs to iteratively achieve improvements of positioning estimate accuracy for each UE. This positioning procedure may allow for achievement of multiple levels of accuracy for position estimates to satisfy the accuracy specified for different applications and use cases. Conveniently, hierarchical positioning procedures disclosed herein may be shown to be agile by implementing active tracking of dynamic UEs.

In a user-centric hierarchical positioning procedure disclosed herein, a signaling mechanism may be shown allow UEs to initiate a positioning procedure in case of its position accuracy being degraded due to shadowing, blockage or being out of range of a TP. This positioning procedure may achieve multiple levels of accuracy (represented by position estimation MSE) to satisfy accuracy specifications of different applications and use cases. Conveniently, user-centric hierarchical positioning procedures disclosed herein may be shown to extend an effective range of a given TP.

According to an aspect of the present disclosure, there is provided a method for a first device associated with a first tier of devices. The method includes obtaining an absolute position for the first device, where the absolute position relates to a position in a global coordinate system. The method further includes obtaining a relative position for a second device. The second device is characterized as being part of a second tier of devices distinct from the first tier of devices. The relative position for the second device is relative to the first device. The method further includes transmitting, to a third device, position information, such that the third device is enabled to obtain an estimate for the absolute position for the second device. The position information includes an indication of an estimate for the absolute position for the first device and an indication of an estimate for the relative position for the second device. In other aspects, there is provided an apparatus adapted to carry out this method. In other aspects there is provided a computer-readable storage medium comprising instructions to carry out this method.

According to an aspect of the present disclosure, there is provided a method of maintaining a database of entries referencing a plurality of devices. The method includes receiving feedback from a device, the feedback including a position estimate and a position estimation mean squared error (MSE) associated with the position estimate. The method further includes adding, to the database, an entry associated with the device. The method further includes characterizing, in the database, the device as located in a given tier, the characterizing based on the position estimation MSE being greater than a first threshold associated with the given tier. In other aspects, there is provided an apparatus adapted to carry out this method. In other aspects there is provided a computer-readable storage medium comprising instructions to carry out this method.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates, as a block diagram, a sensing management function, in accordance with aspects of the present application;

FIG. 6 illustrates example steps in a method of building a map in accordance with aspects of the present application;

FIG. 7 illustrates example steps in a method of preparing feedback in accordance with aspects of the present application;

FIG. 8 illustrates an example position estimation MSE map built according to the method of FIG. 6;

FIG. 9 illustrates, in a signal flow diagram, a network-centric approach to forming a cluster, in accordance with aspects of the present application;

FIG. 10 illustrates, in a signal flow diagram, a user-centric approach to forming a cluster, in accordance with aspects of the present application;

FIG. 11 illustrates example initial steps in a hierarchical positioning procedure, in accordance with aspects of the present application;

FIG. 12 illustrates, in a signal flow diagram, an example exchange between a terrestrial transmit receive point, an Anchor user equipment (UE) and a Target UE, in accordance with aspects of the present application; and

FIG. 13 illustrates, in a signal flow diagram, an example exchange between a terrestrial transmit receive point, an Anchor UE and a Target UE to address shadowing or blockage of the Target UE, in accordance with aspects of the present application.

### DETAILED DESCRIPTION OF ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

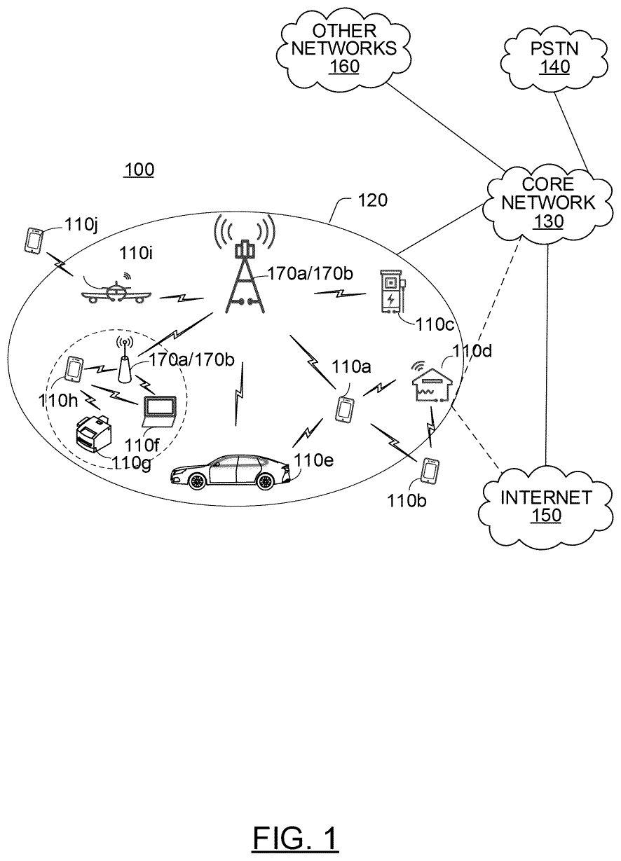

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

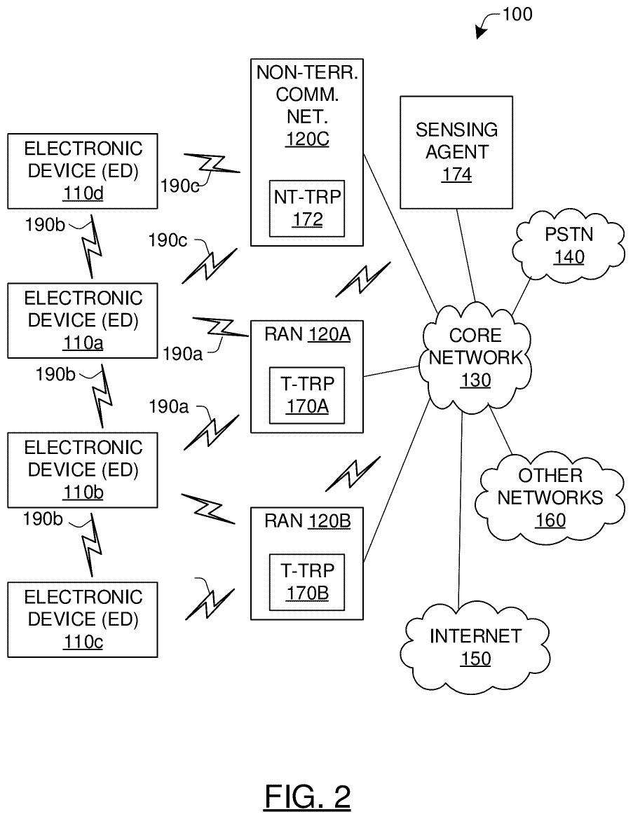

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), single-carrier FDMA (SC-FDMA) or Direct Fourier Transform spread OFDMA (DFT-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

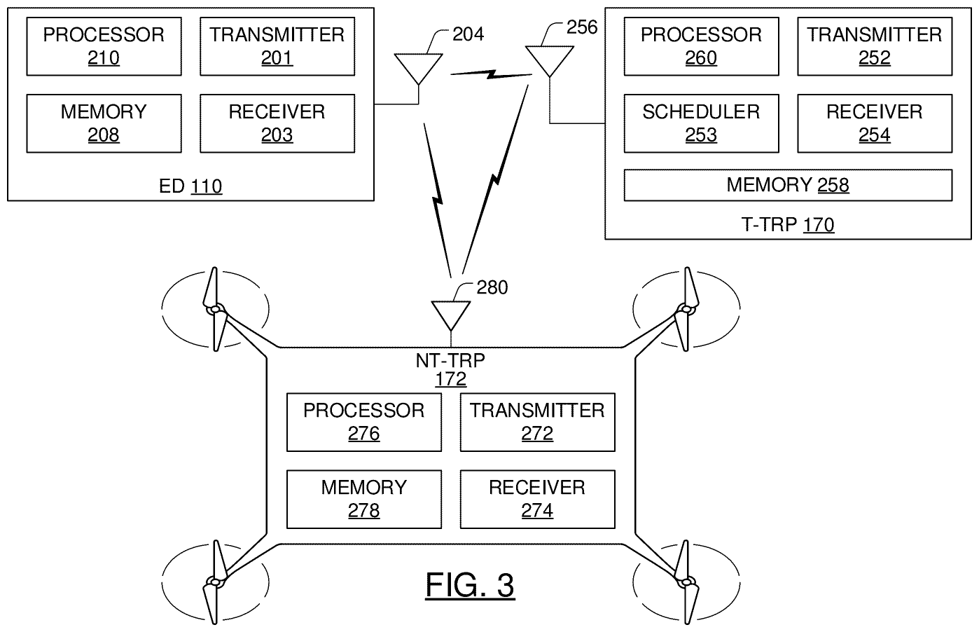

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a watch, head mounted equipment, a pair of glasses, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. A panel is a unit of an antenna group, or antenna array, or antenna sub-array, which unit can control a Tx beam or a Rx beam independently. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

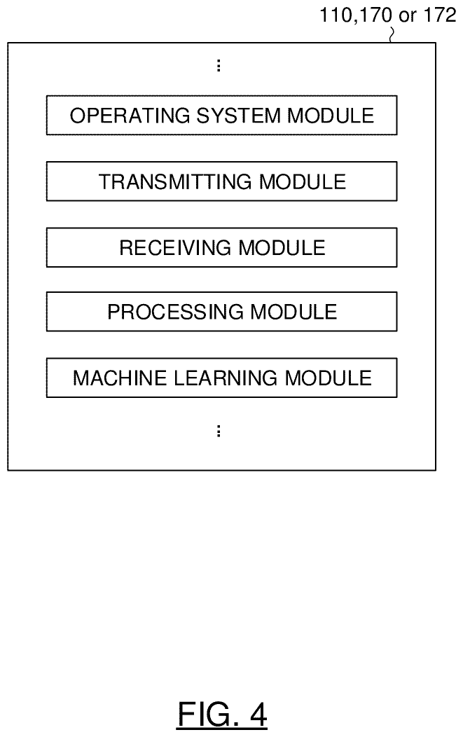

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

UE position information may be used in cellular communication networks to improve various performance metrics for the network. Such performance metrics may, for example, include capacity, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including UE location in a global coordinate system, UE velocity and direction of movement in the global coordinate system, orientation information and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system is typically separate from the communication system, it could be advantageous to gather the information using an integrated system, which reduces the hardware (and cost) in the system as well as the time, frequency or spatial resources needed to perform both functionalities. However, using the communication system hardware to perform sensing of UE pose and environment information is a highly challenging problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. In some cases, a plurality of sensing agents 174 may be implemented and may communicate with each other to jointly perform a sensing task. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANs 120.

A sensing node may combine sensing-based techniques with reference signal-based techniques to enhance UE pose determination. This type of sensing node may also be known as a node that implements a sensing management function (SMF). In some networks, the SMF may also be known as a node that implements a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

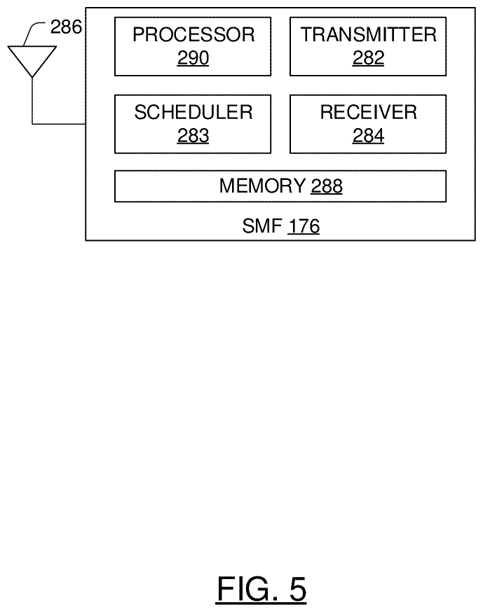

As shown in FIG. 5, an SMF 176, when implemented as a physically independent entity, includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the UE 110) takes part in process of determining the pose of the enquirer. The enquirer may transmit or receive and process (or both transmit and receive/process) a signal specific to pose determination process. Positioning techniques based on a global navigation satellite system (GNSS) such as the known Global Positioning System (GPS) are other examples of the active pose estimation paradigm. Various positioning technologies are also known in NR systems and in LTE systems.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

The term RADAR originates from the phrase Radio Detection and Ranging; however, expressions with different forms of capitalization (e.g., Radar and radar) are equally valid and now more common. Radar is typically used for detecting a presence and a location of an object. A radar system radiates radio frequency energy and receives echoes of the energy reflected from one or more targets. The system determines the pose of a given target based on the echoes returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g., in millimeter wave bands) and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp”, orthogonal frequency-division multiplexing (OFDM), cyclic prefix (CP)-OFDM, and Discrete Fourier Transform spread (DFT-s)-OFDM.

In an embodiment, the sensing signal is a linear chirp signal with bandwidth B and time duration T. Such a linear chirp signal is generally known from its use in FMCW radar systems. A linear chirp signal is defined by an increase in frequency from an initial frequency, f_{chirp0}, at an initial time, t_{chirp0}, to a final frequency, f_{chirp1}, at a final time, t_{chirp1} where the relation between the frequency (f) and time (t) can be expressed as a linear relation of f-f_{chirp0}=a (t-t_{chirp0}), where

$$α = \frac{{f}_{chirp 1} - {f}_{chirp 0}}{{t}_{chirp 1} - {t}_{chirp 0}}$$

is defined as the chirp slope. The bandwidth of the linear chirp signal may be defined as B=f_{chirp1}−f_{chirp0} and the time duration of the linear chirp signal may be defined as T=t_{chirp1}−t_{chirp0}. Such linear chirp signal can be presented as e^{jπat2} in the baseband representation.

Precoding, as used herein, may refer to any coding operation(s) or modulation(s) that transform an input signal into an output signal. Precoding may be performed in different domains and typically transforms the input signal in a first domain to an output signal in a second domain. Precoding may include linear operations.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. In the current case, it is hardly possible to implement terrestrial access-points/base-stations infrastructure in areas like oceans, mountains, forests, or other remote areas.

The terrestrial communication system may be a wireless communications system using 5G technology and/or later generation wireless technology (e.g., 6G or later). In some examples, the terrestrial communication system may also accommodate some legacy wireless technologies (e.g., 3G or 4G wireless technology). The non-terrestrial communication system may be a communications system using satellite constellations, like conventional Geo-Stationary Orbit (GEO) satellites, which utilize broadcast public/popular contents to a local server. The non-terrestrial communication system may be a communications system using low earth orbit (LEO) satellites, which are known to establish a better balance between large coverage area and propagation path-loss/delay. The non-terrestrial communication system may be a communications system using stabilized satellites in very low earth orbits (VLEO) technologies, thereby substantially reducing the costs for launching satellites to lower orbits. The non-terrestrial communication system may be a communications system using high altitude platforms (HAPs), which are known to provide a low path-loss air interface for the users with limited power budget. The non-terrestrial communication system may be a communications system using Unmanned Aerial Vehicles (UAVs) (or unmanned aerial system, “UAS”) achieving a dense deployment, since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs may be coupled to integrate satellite communications to cellular networks. Emerging 3D vertical networks consist of many moving (other than geostationary satellites) and high altitude access points such as UAVs, HAPs and VLEOs.

MIMO technology allows an antenna array of multiple antennas to perform signal transmissions and receptions to meet high transmission rate requirements. The ED 110 and the T-TRP 170 and/or the NT-TRP may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the T-TRP 170 and/or the NT-TRP 172 configured with a large number of antennas has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectral efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectral efficiency. A large number of antenna units of the T-TRP 170 and/or the NT-TRP 172 also enable each user to have better spatial directivity for uplink and downlink transmission, so that the transmitting power of the T-TRP 170 and/or the NT-TRP 172 and an ED 110 is reduced and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and users and the effect of noise can be reduced. The plurality of advantages described hereinbefore enable large-scale MIMO to have a magnificent application prospect.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include: a panel; and a beam.

A beam may be formed by performing amplitude and/or phase weighting on data transmitted or received by at least one antenna port. A beam may be constructed in analog (RF) domain by phase shifters, in digital domain (baseband) through precoding or in a hybrid analog/digital domain. A beam may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or a SSB resource identifier, or an SRS resource identifier, or other reference signal resource identifier.

There are two possible conventional solutions that lead to decreasing the NLOS-bias while using the current positioning techniques such as NR E-CID, DL-TODA and UL-AOA. The first conventional solution involves increasing the number of deployed reference points. The second conventional solution involves decreasing the distance between the existing reference points and the UEs by employing the reference points closer to the UEs. However, deploying more reference points may be considered to be costly and restricting the distance between reference points and the UEs is not guaranteed to work due to factors such as the dynamicity of the environment and the mobility of the UEs.

Aspects of the present application relate to positioning procedures that can be implemented in the presence of current positioning techniques and that may act to alleviate the NLOS-bias problem. It is proposed to use sidelinks between UEs to initiate cooperation between UEs such that certain selected UEs can work as reference points or relays for other UEs. Moreover, triggering cooperation among UEs by forming UE clusters may be shown to help to decrease signaling overhead associated with cooperation. Positioning procedures proposed herein may be shown to dynamically narrow down the distance between many reference points and a given UE, thereby increasing the possibility of having one reference point or more than one reference point in the line of sight condition for the given UE, thereby alleviating the NLOS-bias.

Aspects of the present application may be shown to tackle problems associated with current NR positioning techniques. Such problems include a reliance on too few Anchor UEs (nodes that transmit positioning reference signals) with static locations and a high susceptibility to large NLOS bias (large location offset). Aspects of the present application relate to methods for providing high-resolution position estimation and methods for agile position tracking. These methods have multiple levels of accuracy. The levels of accuracy may allow for a hierarchical arrangement. The levels of accuracy may be expressed as a position estimation mean squared error (MSE).

Through the implementation of a solution that may be adapted for multiple levels of accuracy, a position accuracy may be achieved that is appropriate to a particular application or use case. The levels of accuracy may also be dynamically configured to adapt to a dynamic environment.

In addition, aspects of the present application may be shown to extend a positioning range of a given network to, thereby, reach blocked or shadowed UEs. Accordingly, network coverage may be enhanced in terms of the positioning services.

According to aspects of the present application, UEs may be dynamically grouped. The grouping may be based on a dynamically updated position estimation MSE map maintained at a T-TRP. Additionally, grouping may be implemented in a hierarchical and cooperative manner, such that some UEs act, in a higher tier, as an Anchor UE to other UEs in lower tiers. The terms “higher” and “lower,” when used in the context of tiers, may be defined differently so that, in some aspects of the present application, some UEs in lower tiers may act as an Anchor UE to other UEs in higher tiers. Furthermore, the UEs may be understood to self-organize into clusters of UEs. A cluster of UEs may be represented by a single, representative UE to reduce signaling overhead between UEs in a given UE cluster and various Anchor UEs and/or T-TRPs. Moreover, cooperation between UEs in the same cluster may be based on sensing and on sharing, among the UEs, a relative position estimate and a position estimation MSE associated with the relative position estimate. A positioning procedure, implemented in accordance with aspects of the present application, may be initiated by a UE (known as a bottom-up positioning procedure) or by the T-TRP (known as a top-down positioning procedure). More completely, it may be considered that each position procedure includes a UE-cluster forming step and hierarchical positioning step. The top-down positioning procedure includes network-centric UE-cluster forming and network-centric hierarchical positioning. In contrast, the bottom-up positioning procedure includes user-centric UE-cluster forming and user-centric hierarchical positioning. Between the top-down positioning procedure and the bottom-up positioning procedure, there are another two positioning that may be formed by mixing a network-centric step and a user-centric step.

Aspects of the present application relate to position-estimation-MSE-based hierarchical cooperative positioning. Various aspects include dynamic positioning procedures and signaling mechanisms. Respective positions of UEs in a network may be accurately obtained and maintained based on a multi-phase positioning process.

In a top-down version of the multi-phase positioning process, the role of a first phase is to obtain coarse position information of UEs in a serving area and build a so-called position estimation MSE map. The role of a subsequent phase is to use the position estimation MSE map to dynamically identify Anchor UEs, Target UEs and UE clusters. The subsequent phase further involves use of the position estimation MSE map to initialize a cooperative positioning procedure.

In a bottom-up version of the multi-phase positioning process, the role of a first phase is to self-obtain coarse relative/position information estimates at UEs in a cluster to build a so-called relative position estimation MSE map. The role of a subsequent phase is to use the relative position estimation MSE map to identify Anchor UEs, Target UEs and UE clusters. The subsequent phase further involves use of the relative position estimation MSE map to initialize a cooperative positioning procedure.

In the multi-phase positioning process, the role of the phases that follow the first phase is to increase the accuracy and the reliability of the respective position estimates for the UEs by allowing cooperation. The cooperation may be implemented among UEs within same cluster to, thereby, sense the environment and surrounding UEs and to share, with nearby UEs, their relative position estimates and the position estimation MSE associated with their relative position estimates. This type of cooperation may be called intra-cluster cooperation. The cooperation may be implemented among UEs from different clusters, where a UE from a first cluster can act as an Anchor UE to Target UEs from a second cluster. This type of cooperation may be called inter-cluster cooperation.

One hierarchal positioning method contemplated herein is based on cooperation between UEs forming a cluster while a T-TRP 170 is orchestrating the process.

Another hierarchal positioning method contemplated herein is based on the cooperation between UEs where some UEs work as representative UEs to other UEs while the T-TRP 170 is orchestrating the process.

For isolated clusters/UEs, i.e., for those clusters/UEs that do not have a direct LOS link to a T-TRP 170, a cooperative positioning method may be initiated by a blocked and out-of-range Target UE 110 and supervised by a T-TRP 170. The cooperative positioning methods may be based on using an intermediate UE/cluster as a relay between the T-TRP 170 and the blocked and out-of-range Target UE 110. A hierarchy of these cooperative methods may be based on consistently decreasing the position estimation MSEs till achieving an accuracy threshold associated with different applications or use cases. Moreover, the accuracy and reliability of UE position estimates, i.e., achievable position estimation MSEs, may be sequentially enhanced by narrowing down the area of Anchor UEs 110 around Target UEs 110 by arranging the T-TRP 170 to dynamically select Anchor UEs 110 that have the most accurate position information, i.e., the lowest position estimation MSE. Such narrowing and selecting may be shown to directly enhance the possibility of LOS, thereby increasing positioning accuracy. The signaling mechanisms for the different hierarchical cooperative positioning methods may be shown to maintain the position estimation MSE maps fresh and updated in those cases wherein each UE 110 keeps updating the T-TRP 170 with an updated position estimate and a position estimation MSE to associate with the updated position estimate. The T-TRP 170 may also be enabled to update Target UEs 110 with the positions of reliable Anchor UEs 110.

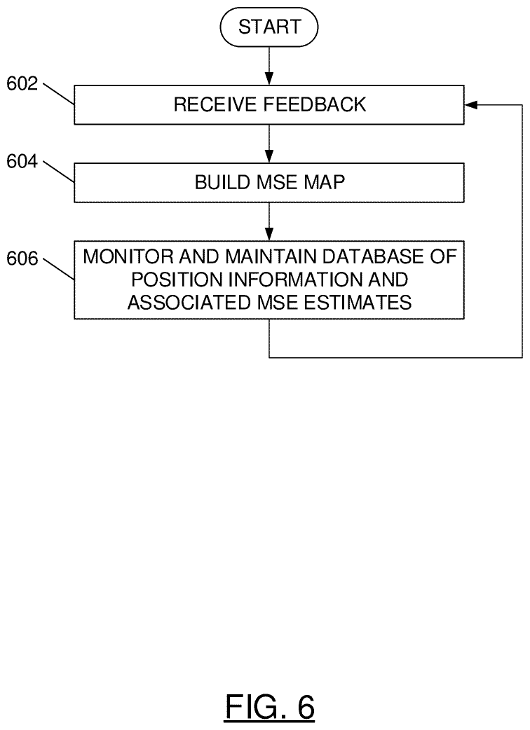

FIG. 6 illustrates example steps in a method, carried out by a T-TRP 170, of building a position estimation MSE map. According to aspects of the present application, the T-TRP 170 may receive (step 602), from UEs 110, feedback. The feedback allows each UE 110, of a plurality of UEs 110, to report a position information and a position estimation MSE associated with the position information. The position information may be estimated position information or so-called coarse position information. The T-TRP 170 may then build (step 604) a position estimation MSE map based on the feedback. Initially, it is expected that position information, received (step 602) from a given UE 110, is associated with a relatively high position estimation MSE.

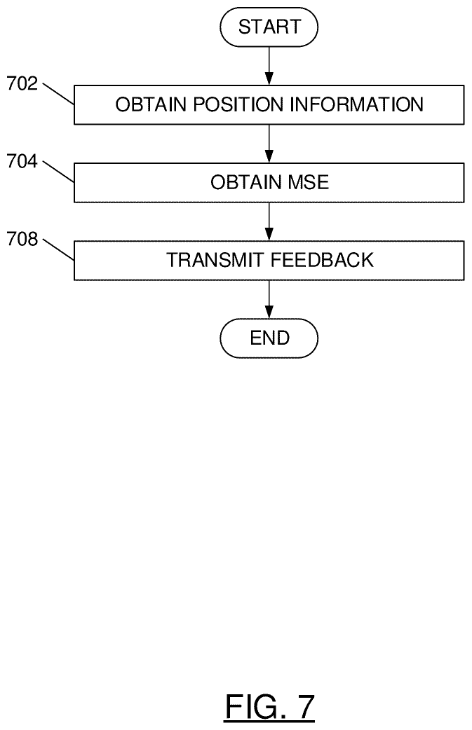

FIG. 7 illustrates example steps in a method of preparing feedback for the T-TRP 170. The steps are presented as carried out by a single UE 110 but should be understood to be representative of steps carried out by each UE 110 among a plurality of UEs 110.

The UE 110 may obtain (step 702) position information using known GPS-based position estimating techniques and/or known NR-positioning position estimating techniques. Alternatively or additionally, the UE 110 may obtain (step 702) position information using sensing techniques that rely upon technology such as Radar, Lidar, digital cameras, etc.

Upon having obtained (step 702) position information, the UE 110 may obtain (step 704) an MSE estimate to associate with the position information. It is contemplated that the UE 110 may obtain (step 704) the MSE estimate based on one of multiple approaches. In one approach, the UE 110 may obtain (step 704) the MSE estimate based on a variance of position information obtained from different sources. In another approach, the UE 110 may obtain (step 704) the MSE estimate based on using some predefined MSE look-up tables. One example look-up table may be indexed by the signal-to-noise ratio (SNR) of received signals. The MSE for any estimate of a nonrandom parameter has a lower bound, known as the Cramer-Rao Lower Bound (CRLB). Accordingly, another example look-up table may be indexed by CRLB.

As part of obtaining (step 704) the MSE estimate, the UE 110 may also obtain an indication of the reliability of the MSE estimate, say, on the basis of sensing performed by the UE 110 and/or environment sensing performed by one or more network entity distinct from the UE 110. For sensing performed by the UE 110, internal cameras, Radar equipment and/or Lidar equipment may provide some information about LOS availability and nearby main reflectors. From the information, the UE 110 may obtain an indication of the reliability of the MSE estimate. On the basis of environment sensing performed by one or more network entity distinct from the UE 110, the UE 110 may receive an RF map. From the RF map, the UE 110 may obtain information about LOS availability and nearby main reflectors. From the information about LOS availability and nearby main reflectors, the UE 110 may obtain an indication of the reliability of a given MSE estimate.

The UE 110 may then transmit (step 708), to the T-TRP 170, feedback. The feedback may include the position estimate (obtained in step 702), the associated MSE estimate (obtained in step 704) and the indication of the reliability of the MSE estimate (obtained in step 704).

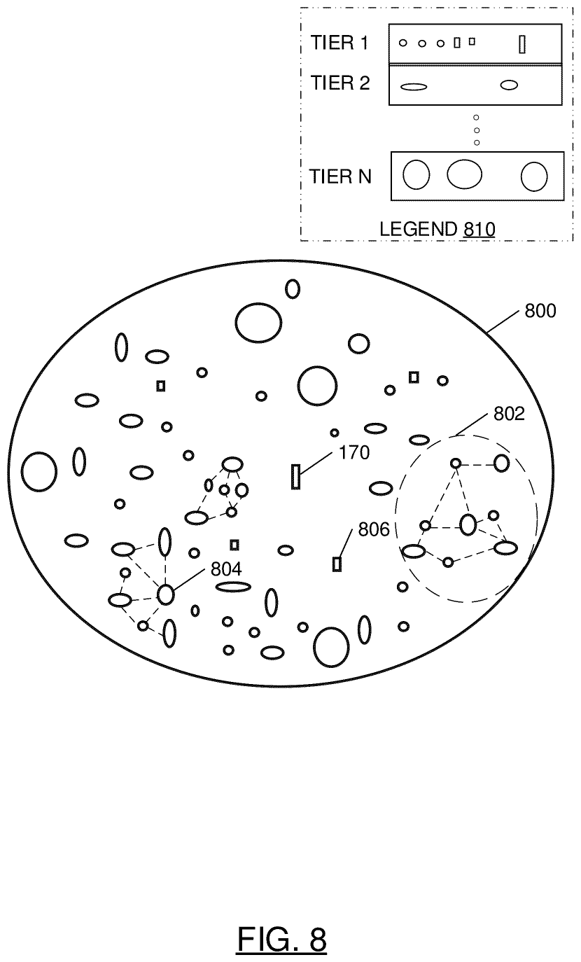

An example position estimation MSE map 800 is illustrated in FIG. 8, built according to the method illustrated in FIG. 6. The example position estimation MSE map 800 includes a plurality of ovals. Rather than representing a particular position of a particular UE 110, the ovals represent a position estimation MSE estimate specified in feedback received from the particular UE 110, where the position estimation MSE estimate is centered around position estimate specified in feedback received from the particular UE 110.

The example position estimation MSE map 800 includes various pluralities of ovals with connecting lines. These pluralities may be understood to be clusters of UEs 110. One cluster is associated with reference numeral 802. Each of the clusters of UEs 110 may be understood to include a cluster representative UE 110. One cluster representative UE 110 is associated with reference numeral 804. In addition to ovals, the example position estimation MSE map 800 includes rectangles. Some of the rectangles are representative of T-TRPs 170. Others of the rectangles are representative of fixed Anchor UEs. One fixed Anchor UE is associated with reference numeral 806.

The example position estimation MSE map 800 is associated, in FIG. 8, with a legend 810. When building (step 604) a position estimation MSE map like the example position estimation MSE map 800, the T-TRP 170 may categorize each UE 110, using the position estimation MSE associated with the position information, into a tier. The legend 810 indicates that several small ovals have been categorized in tier 1. Additionally, fixed network nodes that are associated with a relatively low position estimation MSE are located in tier 1. The legend 810 indicates that several medium-sized ovals have been categorized in tier 2. The legend 810 further indicates that several large-sized ovals (each large-sized oval representative of a relatively high position estimation MSE) have been categorized in a highest tier, labelled in FIG. 8 as tier N. In some embodiments, the position estimation MSE map 800 may include a plurality of tiers, wherein each tier includes UEs associated with a position estimation MSE between an n^{th} tier MSE lower threshold, Iₙ, and an n^{th} tier MSE upper threshold, un. In the mathematical form, the n^{th} tier, denoted by Tₙ, can be written as

$${T}_{n} = \{ UE i \vert {l}_{n} \leq MSE ( i ) \leq {u}_{n} \} .$$

When building (step 604) a position estimation MSE map like the example position estimation MSE map 800, the T-TRP 170 may set different MSE thresholds between tiers. The thresholds may be set to represent different accuracy levels associated various use-cases and applications. A given UE 110 may be located in a certain tier according to the position estimation MSE associated with its position information. It may be considered a goal of aspects of the present application to, eventually, categorize the given UE 110 in a higher tier. That is, it may be considered a goal of aspects of the present application to lower the position estimation MSE associated with the position information for the given UE 110 and, indeed, to lower the position estimation MSE associated with the position information for all UEs 110 referenced in the example position estimation MSE map 800. A position estimation MSE map, as built and maintained by a given T-TRP 170, may be understood to dynamically change with time, due to several factors. These factors include the movement of UEs 110 and successive iterations of the cooperative algorithms proposed herein as aspects of the present application. It follows that the T-TRP 170 continuously monitors and maintains (step 606) a database of position information and associated position estimation MSEs for a plurality of UEs 110. That is, the database includes an entry for each UE 110 from which the T-TRP 170 has received feedback.

Aspects of the present application relate to enabling UEs 110 that are close to each other to cooperatively form a cluster (see the cluster 802 in FIG. 8). The UEs 110 may employ UE sensing when forming a cluster. UE sensing may be considered to be useful in obtaining accurate relative position information and accurate relative position information may be considered to be useful in the act of cooperative cluster formation. Each cluster may be represented by a cluster representative (see the cluster representative 804 in FIG. 8).

A subset of UEs 110 may cooperatively form a cluster on the basis of the proximity of the position information associated with each UE 110 in the subset of UEs 110, the relative speed associated with each UE 110 in the subset of UEs 110 and the movement direction associated with each UE 110 in the subset of UEs 110.

The task of forming a cluster can be initiated by the T-TRP 170 or by a UE 110. When the forming of the cluster is initiated by the T-TRP 170, the forming of the cluster may be called a “network-centric” approach to forming a cluster. When the forming of the cluster is initiated by a UE 110, the forming of the cluster may be called a “user-centric” approach to forming a cluster. The task of performing hierarchical positioning can also be initiated by the T-TRP 170 or a by a UE 110. That is, in a manner similar to the forming of the cluster, the performing the hierarchical positioning may be accomplished using a network-centric approach or a user-centric approach.

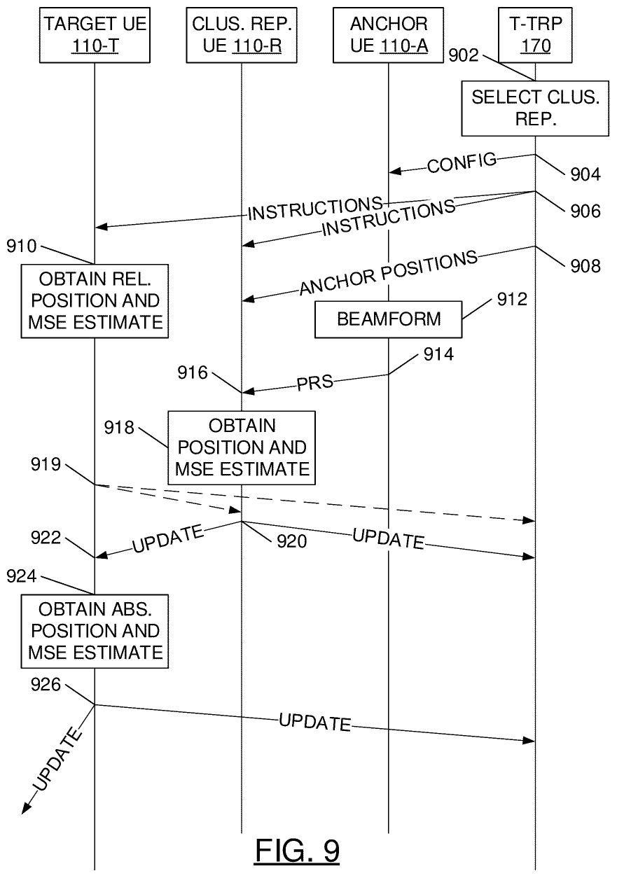

FIG. 9 illustrates, in a signal flow diagram, a network-centric approach to forming a cluster. Initially, the T-TRP 170, using a position estimation MSE map, may select (step 902) one or more UEs 110 as a cluster representative UE 110-R. The selection may be based on the proximity of position information for the selected UE 110-R relative to position information for other UEs 110 in the cluster, the position estimation MSE associated with the position information for the selected UE 110 and the proximity of position information for the selected UE 110-R to known Anchor UEs 110-A, associated with relatively small position estimation MSEs.

The T-TRP 170 may transmit (step 904), to the Anchor UEs 110-A, configuration instructions. The configuration instructions may, for example, include PRS parameters and synchronization parameters. The configuration instructions may, for example, include position information for the selected UE 110-R.

The T-TRP 170 may transmit (step 906), to the cluster representative UE 110-R and the Target UEs 110-T, instructions. The instructions may instruct the Target UEs 110-T in the cluster to cooperate locally with other Target UEs 110-T in their proximity, including the cluster representative UE 110-R. The instructions may instruct the cluster representative UE 110-R to initiate a local positioning/sensing procedure to obtain the relative position of the Target UEs 110-T with respect to the cluster representative UE 110-R.

The T-TRP 170 may transmit (step 908), to the cluster representative UE 110-R, an indication of positions of local Anchor UEs 110-A.

Within the cluster, a given Target UE 110-T may obtain (step 910) an estimate of relative position information for proximate Target UEs 110-T and a position estimation MSE to associate with the relative position information for the proximate Target UEs 110-T. Proximate Target UEs 110-T are nearest to the given Target UE 110-T. The estimate of relative position information may be obtained (step 910) by sensing. The sensing may involve sending sensing reference signals (SeRS) and processing measurements of received reflections of the SeRS. The sensing may, for example, involve use of cameras, Lidar equipment or Radar equipment. The sensing may involve NR sidelinks using SRS/PRS and measurements. Each UE 110 may build a small position estimation MSE map that contains relative position of each sensed UE 110. Entries in the small position estimation MSE map may be labeled by UE IDs, labeled by relative position or labeled by angle to the sensed UE.

The transmission (step 908), from the T-TRP 170 to the cluster representative UE 110-R, the indication of positions of local Anchor UEs 110-A may be seen to initiate an Anchor-Target UE positioning procedure for those UEs 110-R that the T-TRP 170 has selected as cluster representative UEs. It should be clear that each cluster representative UE 110-R may be associated with a plurality of proximate Target UEs 110-T.

Based upon receipt of the configuration information transmitted (step 904) by the T-TRP 170, the Anchor UE 110-A may configure (step 912) some beamformings to prepare to transmit a PRS or a plurality of PRSs. The beamforming information may be obtained based on the knowledge of the approximate position of the cluster representative UE 110-R or the approximate position of the Target UEs 110-T. The Anchor UE 110-A may then transmit (step 914), toward the cluster representative UE 110-R, a PRS.

Upon receiving (step 916), from the Anchor UE 110-A, the PRS, the cluster representative UE 110-R may obtain (step 918) an absolute position estimate and a position estimation MSE to associate with the absolute position estimate for itself. The term “absolute position” may be understood to refer to a position in a global coordinate system. In contrast, the term “relative position” may be understood to refer to a position determined with respect to another device.

Upon obtaining (step 910) the relative position estimate and the position estimation MSE for the other Target UEs 110-T in the cluster, the Target UE 110-T may optionally transmit (step 919), to the cluster representative UE 110-R, feedback, the feedback including the relative position estimates and the position estimation MSEs. Upon obtaining (step 910) the relative position estimate and the position estimation MSE for the other Target UEs 110-T in the cluster, the Target UE 110-T may optionally transmit (step 919), to the T-TRP 170, feedback, the feedback including the relative position estimates and the position estimation MSEs. The PUSCH may be used for transmitting (step 919) the feedback.

In review, one aspects of the present application relates to the cluster representative UE 110-R obtaining relative position information (including position estimation MSE) for the Target UEs 110-T in the cluster. The cluster representative UE 110-R may subsequently provide this information to the T-TRP 170. In this aspect, the Target UEs 110-T do not obtain any relative position information and all relative position information is obtained by the cluster representative UE 110-R. In other aspects of the present application, each Target UE 110-T performs relative position measurement with respect to the cluster representative UE 110-R. Each Target UE 110-T may then provide this information directly to the T-TRP 170 or indirectly to the T-TRP 170 via the cluster representative UE 110-R.

Upon obtaining (step 918) the absolute position estimate and the position estimation MSE, the cluster representative UE 110-R may transmit (step 920), to the T-TRP 170, the absolute position estimate and the position estimation MSE. The cluster representative UE 110-R may use the relative position estimate and the position estimation MSE transmitted (step 919) by the Target UEs 110-T in combination with the absolute position estimate and the position estimation MSE obtained in step 918 to obtain an absolute position estimate and a position estimation MSE for each of the Target UEs 110-T. The cluster representative UE 110-R may transmit (step 920), to the plurality of proximate Target UEs 110-T, the absolute position estimate and the position estimation MSE specific to the cluster representative UE 110-R. The cluster representative UE 110-R may also transmit (step 920), to the T-TRP 170, the absolute position estimate and the position estimation MSE for each of the Target UEs 110-T in the cluster.

Upon receiving (step 922), from the cluster representative UE 110-R, the absolute position estimate and the position estimation MSE specific to the cluster representative UE 110-R, the Target UE 110-T may then obtain (step 924) new absolute position information and a position estimation MSE to associate with the new absolute position information. The Target UE 110-T may obtain (step 924) the new absolute position information by combining the absolute position estimate of the cluster representative UE 110-R, received in step 922, with a relative position estimate obtained in step 910. The Target UE 110-T may then transmit (step 926) the new absolute position estimate and the position estimation MSE to the T-TRP 170.

The Target UE 110-T may also transmit (step 926) the new absolute position estimate and the position estimation MSE to a plurality of downstream Target UEs 110 (not shown). The downstream Target UEs 110 are those UEs 110 that are proximate to the Target UE 110-T, but are distinct from the cluster representative UE 110-R from which the absolute position estimate has been received in step 922.

For the network-centric approach to forming a cluster, with reference to FIG. 9, the signaling from the T-TRP 170 to the Anchor UEs 110-A is mainly configuration instructions. Recall that the configuration instructions may, for example, include PRS and synchronization parameters. The configuration instructions may, for example, include coarse position information for the selected cluster representative UE 110-R.

A goal of the transmission (step 904) of the configuration instructions is to facilitate the beamforming (step 912) towards the cluster representative UE 110-R for the transmission (step 914) of PRS from the Anchor UEs 110-A. Additionally, the T-TRP 170 may transmit (step 904), as part of the configuration instructions, the locations of the Anchor UEs 110-A to the cluster representative UE 110-R. Further, the T-TRP 170 may transmit (step 906) signaling to all UEs 110 in clusters to instruct (step 906) the Target UEs 110-T in the cluster to announce the cluster representative UE 110-R.

FIG. 9 illustrates a T-TRP 170, an Anchor UE 110-A, a cluster representative UE 110-R and a Target UE 110-T. Notably, in some aspects of the present application, there may only be a T-TRP 170, an Anchor UE 110-A and a Target UE 110-T. That is, it is contemplated that there may be a case wherein there is no cluster representative UE 110-R. In such a case, the Anchor UE 110-A may transmit a PRS directly to the Target UE 110-T. In further aspects of the present application, there may only be a T-TRP 170, a cluster representative UE 110-R and a Target UE 110-T. That is, it is contemplated that there may be a case wherein there is no Anchor UE 11-A. These two cases are special cases of the general framework depicted in FIG. 9. In the two special cases, the signaling and feedback should be modified accordingly.

In the user-centric approach to forming a cluster, a group of UEs 110 cooperate locally with each other to select one or more cluster representative Anchor UEs 110.

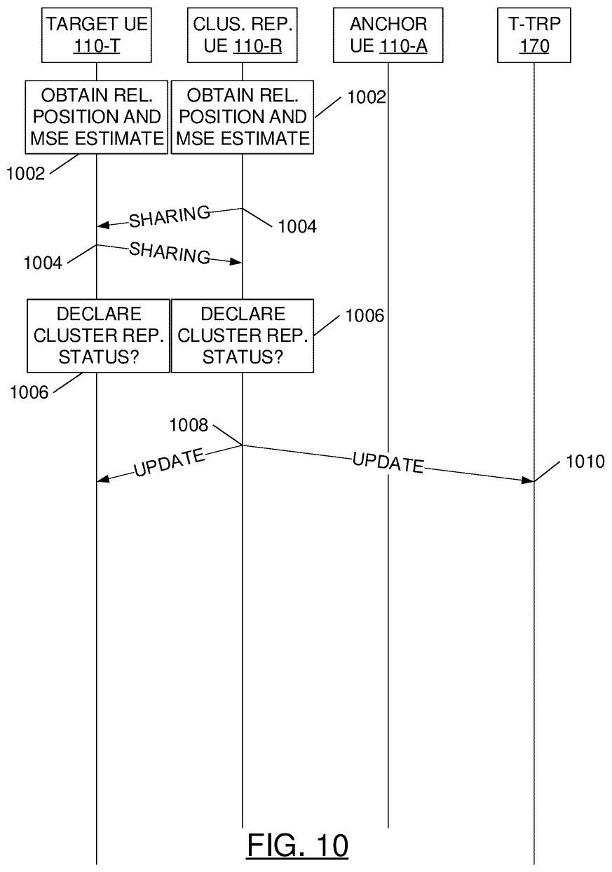

FIG. 10 illustrates, in a signal flow diagram, a user-centric approach to forming a cluster. Initially, individual UEs 110-T, 110-R obtain (step 1002), through use of a sensing operation, an estimate of relative position information for proximate UEs 110 and an MSE estimate to associate with the relative position information for the proximate UEs 110. The individual UEs 110-T, 110-R may sense the environment and determine relative distances to proximate UEs 110. Upon completing the obtaining (step 1002), the individual UEs 110-T, 110-R may build a relative position MSE map. The individual UEs 110-T, 110-R may then transmit (step 1004), to each other, an indication of a quantity of proximate UEs 110. It follows that the individual UEs 110-T, 110-R also receive, from the proximate UEs 110, indications of a quantities of proximate UEs 110. Each UE 110 may then self-determine (step 1006) whether the UE 110 has more proximate UEs 110 than its proximate UEs. Upon determining (step 1006) that it has more proximate UEs 110 than its proximate UEs, the UE 110-R may transmit (step 1008) an update. The update may include an announcement of self-appointment as the cluster representative UE. Upon determining (step 1006) that it does not have more proximate UEs 110 than the nearby UEs 110, the Target UE 110-T may wait to receive an update transmitted (step 1008) from another UE 110 announcing self-appointment as the cluster representative UE. The update, transmitted (step 1008) by the cluster representative UE 110-R, may also provide, to the T-TRP 170, an indication that this UE is declared as cluster representative, which may be followed by an updated position estimate for the cluster representative UE 110-R and a position estimation MSE associated with updated position estimate.

In some aspects of the present application, relative position estimation MSE of the proximate UEs 110 may be used as a metric to declare the cluster representative UE 110-R. In some aspects of the present application, a quantity of proximate UEs 110 having position estimation MSEs below a certain threshold can be used as a metric to declare the cluster representative UE 110-R.

In a manner similar to the network-centric approach to forming a cluster, subsequent to receiving (step 1010) the update from the cluster representative UE 110-R, the T-TRP 170 may initiate an Anchor-Target UE positioning procedure through communication with the cluster representative UE 110-R. That is, steps 904 through 926 may be carried out subsequent to the cluster representative UE 110-R announcing itself as the cluster representative UE.

For the user-centric approach to forming a cluster, the signaling (step 1004) among UEs 110 within the cluster aims to share the relative position measurements and facilitate self-selection of the cluster representative UE 110-R. The signaling (step 1008) from the cluster representative UE 110-R to the T-TRP 170 may be used to inform the T-TRP 170 that the UE 110-R is the cluster representative UE 110-R and to request initiation of the Anchor-Target UE positioning procedure. All of this signaling may be carried out using dynamic (L1) signaling.

Aspects of the present application relate to a hierarchical positioning procedure.

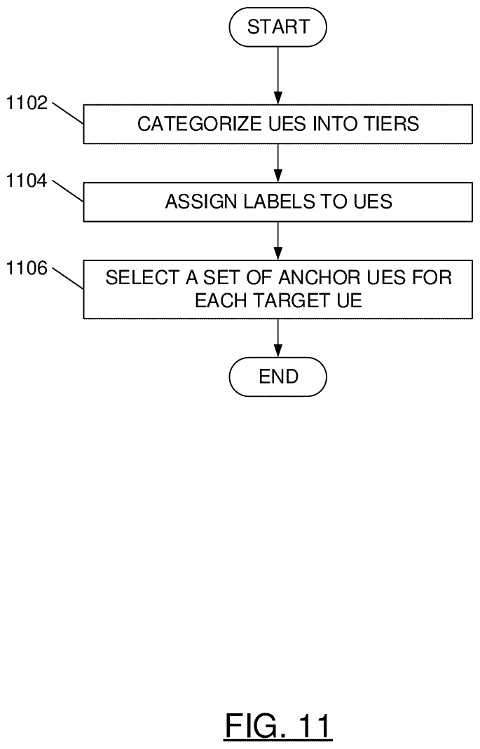

FIG. 11 illustrates example initial steps in a hierarchical positioning procedure.

The hierarchical positioning procedure may be triggered by the T-TRP 170 for a cluster representative UE (not specifically shown in FIG. 11). The hierarchical positioning procedure may also be triggered by the T-TRP 170 for a Target UE 110-T that is not a cluster representative UE. As will be discussed, in accordance with the hierarchical positioning procedure, the T-TRP 170 provides the Target UE 110-T with the locations of the Anchor UEs 110-A. The Target UE 110-T responds by providing feedback, the feedback position information and an MSE estimate associated with the position information. The position information can be relative position to the cluster representative UE 110-R, relative position to the anchor UEs 110-A or absolute position in the global coordinate system. The Target UE 110-T may provide the feedback directly to the T-TRP 170 or indirectly, to a cluster representative UE 110-R or to Anchor UEs 110-A, so that the cluster representative UE 110-R or Anchor UEs 110-A may provide the feedback to the T-TRP 170. The providing and reporting may continue until a predetermined position accuracy has been achieved.

The hierarchical positioning procedure may be initiated upon detection, by the T-TRP 170, that there are more than a threshold number of UEs 110 in a certain tier in the position estimation MSE map (see FIG. 8). The T-TRP 170 may initially categorize (step 1102) each UE 110 into an appropriate tier based on position estimation MSEs.

The T-TRP 170 then assigns (step 1104) one or more than one label to each UE 110. The label may identify each UE 110 as a Target UE, an Anchor UE or both a Target UE and an Anchor UE. The T-TRP 170 may assign (step 1104) the Target UE label to those UEs 110 that have higher position estimation MSE than an MSE threshold associated with one or more applications. The T-TRP 170 may assign (step 1104) the Anchor UE label to those UEs 110 that have a lower position estimation MSE than a connected UE 110 that has been labelled as a Target UE. In many cases, a given UE 110 may be labelled as a Target UE in respect of another UE 110 that has been labelled as an Anchor UE and may be labelled as an Anchor UE in respect of another UE 110 that has been labelled as a Target UE.

Based on the position estimation MSE map, the T-TRP 170 may select (step 1106), for each Target UE, a set of UEs 110 labelled as Anchor UEs. The selecting (step 1106) may be based on a distance between a given Target UE 110-T and a potential Anchor UE 110-A. The selecting (step 1106) may be based on a position estimation MSE associated with position information for the Target UE 110-T and a position estimation MSE associated with position information for a potential Anchor UE 110-A. The selecting (step 1106) may be based on a combination of the distance and the position estimation MSEs.

One set of UEs labelled as Anchor UEs 110-A may be used for improving position information for multiple Target UEs 110-T, where the multiple Target UEs 110-T may have been formed into a cluster as discussed hereinbefore.

The T-TRP 170 may facilitate cooperation between UEs 110 labelled as Target UEs 110-T and the set of UEs 110 labelled as Anchor UEs 110-A by providing, to the set of UEs 110 labelled as Anchor UEs 110-A, coarse position information for the UEs 110 labelled as Target UEs 110-T to, thereby, facilitate position-based beamforming.

The T-TRP 170 may facilitate cooperation between UEs 110 labelled as Target UEs 110-T and the set of UEs 110 labelled as Anchor UEs 110-A by initiating and synchronizing transmission of PRS from the set of Anchor UEs 110-A.

The T-TRP 170 may facilitate cooperation between Target UEs 110-T and the set of Anchor UEs 110-A by providing, to the Target UEs 110-T, position information for the Anchor UEs 110-A to, thereby, facilitate self-positioning at the Target UEs 110-T. Upon receiving a PRS from an Anchor UEs 110-A, the Target UEs 110-T may perform measurements and processing on the PRS to obtain new position information and a position estimation MSE to associate with the new location information. Target UEs 110-T may fuse the new position information with previously obtained position information or only consider the new position information to be valid. At the end of each round of the hierarchical positioning procedure, the T-TRP 170 may receive updated feedback from the Target UEs 110-T regarding their new position information and associated position estimation MSEs. Also, the Anchor UEs 110-A may report, to the T-TRP 170, changes in accuracy of their location information. These steps can be repeated until all UEs 110 have position information associated with a position estimation MSE that is lower than a predetermined MSE threshold.

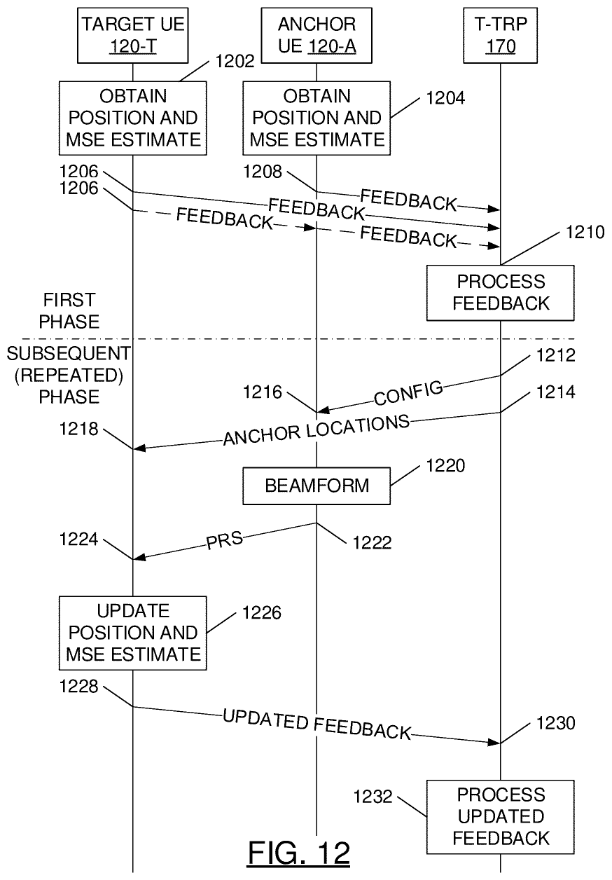

FIG. 12 illustrates, in a signal flow diagram, an example exchange between a T-TRP 170, an Anchor UE 110-A and a Target UE 110-T. The exchange includes signaling from the T-TRP 170 to the UEs 110 and signaling from the UEs 110 to the T-TRP 170.

Initially, the Target UE 110-T obtains (step 1202) position information and an MSE estimate to associate with the position information. Similarly, the Anchor UE 110-A obtains (step 1204) position information and an MSE estimate to associate with the position information. The Target UE 110-T transmits (step 1206), to the T-TRP 170, feedback including the position information and MSE estimate obtained in step 1202. The Anchor UE 110-A transmits (step 1208), to the T-TRP 170, feedback including the position information and MSE estimate obtained in step 1204.

Upon receiving the feedback from the Target UE 110-T and the Anchor UE 110-A, the T-TRP 170 may process (step 1210) the feedback. Processing (step 1210) the feedback may involve the T-TRP 170 building a table of positions of UEs 110 and associated MSE estimates. In a case wherein such a table already exists, processing (step 1210) the feedback may involve the T-TRP 170 updating the table. The T-TRP 170 may also set MSE thresholds that have been discussed hereinbefore with respect to the T-TRP 170 categorizing each UE 110 into an appropriate tier based on MSE estimates (see step 1102 of FIG. 11). Processing (step 1210) the feedback may further involve the T-TRP 170 determining a set of Anchor UEs 110-A to associate with the Target UE 110-T.

Upon completion of the processing (step 1210), the T-TRP 170 may transmit, to the Anchor UE 110-A, configuration information. The configuration information may, for example, include coarse information about the position of the Target UE 110-T. The configuration information may, for example, include configuration and synchronization information specific to a PRS to be transmitted by the Anchor UE 110-A toward the Target UE 110-T.

Upon completion of the processing (step 1210), the T-TRP 170 may transmit, to the Target UE 110-T, position information for the set of Anchor UEs 110-A, including the Anchor UE 110-A illustrated in FIG. 12, which set was determined as part of the processing (step 1210).

Upon receiving (step 1216), from the T-TRP 170, the configuration information, the Anchor UE 110-A may configure (step 1220) some beamforming to prepare to transmit a PRS. The configuring of the beamforming may be based on the configuration information received (step 1216) from the T-TRP 170. The Anchor UE 110-A may then transmit (step 1222), toward the Target UE 110-T, a PRS.

Upon receiving (step 1218), from the T-TRP 170, the position information for the set of Anchor UEs 110-A, the Target UE 110-T may be prepared to receive (step 1224) the PRS from the Anchor UE 110-A.

By obtaining measurements of the PRS received (step 1224) from the Anchor UE 110-A, the Target UE 110-T may process the measurements to obtain (step 1226) updated position information and an updated position estimation MSE to associate with the updated position information. The Target UE 110-T may then transmit (step 1228), to the T-TRP 170, updated feedback. The updated feedback may include the updated position information and the updated position estimation MSE obtained in step 1226.

Upon receiving (step 1230) the updated feedback from the Target UE 110-T, the T-TRP 170 may process (step 1232) the updated feedback. Processing (step 1232) the updated feedback may involve the T-TRP 170 updating the table of positions of UEs 110 and associated position estimation MSEs. The T-TRP 170 may also repeat the action of setting MSE thresholds that have been discussed hereinbefore with respect to the T-TRP 170 categorizing each UE 110 into an appropriate tier based on position estimation MSEs (see step 1102 of FIG. 11). Processing (step 1232) the updated feedback may further involve the T-TRP 170 updating the set of Anchor UEs 110-A that are associated with the Target UE 110-T.

The signaling, illustrated in FIG. 12 from the UEs 110 to the T-TRP 170 and from the T-TRP 170 to the UEs 110, may employ dynamic L1 signaling. Some signaling, including configuration of PRS, which may include mapping function of Anchor UE ID to PRS, may employ higher layer signaling including RRC or MAC-CE.

It is well known that a given mobile UE 110 may move to a position that is out of range of a T-TRP 170 on the basis of being shadowed or blocked by buildings. Aspects of the present application relate to a positioning procedure that involves a UE 110 that is shadowed or blocked making use of proximate UEs 110 for obtaining position information and/or connecting to the T-TRP 170.

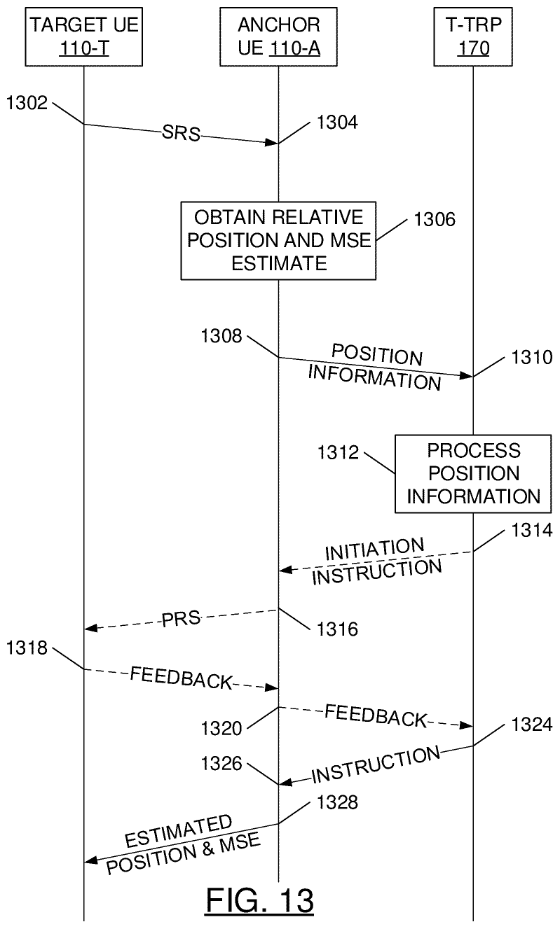

FIG. 13 illustrates, in a signal flow diagram, an example exchange between a T-TRP 170, an Anchor UE 110-A and a Target UE 110-T. The exchange addresses shadowing or blockage of the Target UE 110-T.

The positioning procedure may be initiated by the Target UE 110-T. Initially, the Target UE 110-T may attempt to sense the environment with a goal of locating Anchor UEs 110-A. The attempt may involve the Target UE 110-T transmitting (step 1302) SRS in one or more selected directions. The Target UE 110-T selects directions that are distinct from the direction toward the T-TRP 170, which is known to blocked or shadowed. By using relatively low power when transmitting (step 1302) the SRS, the Target UE 110-T may limit the SRS to only be received by the surrounding Anchor UEs 110-A. Moreover, the SRS may be specifically designed to enable measurement, by the surrounding Anchor UEs 110-A, of the relative position of the Target UE 110-T. The Anchor UEs 110-A that reliably receives (step 1304) the SRS, may be expected to obtain and process measurements to obtain relative distance, time and/or angle of arrival. To “reliably” receive an SRS may be defined as receiving an SRS above certain received signal level (RSL) threshold. The RSL threshold may be defined by the T-TRP 170.

Upon obtaining the measurements, the Anchor UE 110-A illustrated in FIG. 13 and each of the other Anchor UEs 110 (not illustrated in FIG. 13) may process the measurements to obtain (step 1306) an estimated relative position and a position estimation MSE to associate with the estimated relative position. Each of the Anchor UEs 110-A may then transmit (step 1308), to the T-TRP 170, an indication of the estimated relative position and the associated position estimation MSE. Upon receiving (step 1310) these estimated relative positions and associated position estimation MSEs, the T-TRP 170 may process (step 1312) the estimated relative positions and the associated position estimation MSEs to determine, for the Target UE 110-T, an absolute position estimate and a position estimation MSE to associate with the absolute position estimate. If the associated position estimation MSE indicates a suitable accuracy, the processing (step 1312) of the estimated relative position estimates and the associated position estimation MSEs may include the T-TRP 170 selecting one Anchor UE 110-A to transmit, to the Target UE 110-T, an indication of the absolute position estimate and the associated position estimation MSE.

If the associated position estimation MSE does not indicate a suitable accuracy, the T-TRP 170 may assign new Anchor UEs 110-A to the Target UE 110-T based on the estimated relative position and associated position estimation MSE information previously received. Through the assigning (not shown), the T-TRP 170 may be seen to initiate a network-centric positioning procedure, an example of which is illustrated in FIG. 9. The new Anchor UEs 110-A may be not the same as the Anchor UEs 110-A previously used for measurement collection.

Returning to the situation wherein the associated position estimation MSE indicates a suitable accuracy, the T-TRP 170 may transmit (step 1324), to the selected Anchor UE 110-A, the indication of the absolute position estimate and associated position estimation MSE for the Target UE 110-T along with instructions to provide, to the Target UE 110-T, the absolute position estimate and the associated position estimation MSE.

Upon receipt (step 1326) of the absolute position estimate and the associated position estimation MSE for the Target UE 110-T along with the instructions, the Anchor UE 110-A may proceed to transmit (step 1328), to the Target UE 110-T, the absolute position estimate and the associated position estimation MSE.

To decrease the signaling overhead, the T-TRP 170 may provide the Anchor UEs 110-A with a list of Target UEs 110-T for which the Anchor UEs 110-A are expected to perform measurements. If an Anchor UE 110-A receives (step 1304) an SRS from one of the Target UEs 110-T on the list, the Anchor UE 110-A is expected to perform measurements (step 1306) and transmit (step 1308), to the T-TRP 170, estimated relative position and associated position estimation MSE. If an Anchor UE 110-A receives an SRS from one of the Target UEs 110-T that is not on the list, the Anchor UE 110-A is expected to ignore the SRS.

The signaling, illustrated in FIG. 13, from the Anchor UE 110-A to the T-TRP 170 and from the T-TRP 170 to the Anchor UE 110-A may employ dynamic Li signaling. The signaling, illustrated in FIG. 13, from the Anchor UE 110-A to the Target UE 110-T may employ dynamic L1 signaling. Signaling, related to configurations for SRS and PRS as well as the configured RSL level to detect SRS, sent from the T-TRP 170 to Target UE 110-T and Anchor UE 110-A, may be considered semi-static and, accordingly, may employ higher layer signaling, such as RRC and MAC-CE.

FIG. 13 illustrates optional signaling. Responsive to determining (not shown) that position information, for the target UE 110-T, that has been obtained at the T-TRP 170 is not accurate enough to satisfy predetermined Target UE requirements, the T-TRP 170 may initiate the hierarchical positioning procedure. The hierarchical positioning procedure may be initiated, for the target UE 110-T, by transmitting (step 1314) an initiation instruction to a set of Anchor UEs 110-A that reliably received (step 1304) the SRS transmitted in step 1302. The T-TRP 170 may, alternatively, transmit (step 1314) the initiation instruction to another set of Anchor UEs 110-A identified by the T-TRP 170.

A goal of the hierarchical positioning procedure is to achieve a positioning accuracy that satisfies the predetermined Target UE requirements. Responsive to receiving the initiation instruction, the Anchor UEs 110-A may transmit (step 1316) PRS and share their own locations with the Target UE 110-T. Enabled by receipt of the PRS, the Target UE 110-T may obtain a position estimate and a position estimation MSE. The Target UE 110-T may then transmit (step 1318) feedback to the Anchor UEs 110-A. The feedback may include the position estimate and the position estimation MSE. The Anchor UE 110-A may transmit (step 1320) the feedback to the T-TRP 170. Receipt of the feedback may allow the T-TRP 170 to update the position estimation MSE map.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method comprising:
obtaining, by a first device, an absolute position for the first device associated with a first tier of devices, where the absolute position relates to a position in a global coordinate system;
obtaining, by the first device, a relative position for a second device, the second device characterized as being part of a second tier of devices distinct from the first tier of devices, the relative position for the second device being relative to the first device; and
transmitting, by the first device to a third device, position information, wherein the position information enables the third device to obtain an estimate for the absolute position for the second device, the position information including:
an indication of an estimate for the absolute position for the first device; and
an indication of an estimate for the relative position for the second device.

2. The method of claim 1, wherein obtaining the relative position for the second device comprises:
transmitting, by the first device, a reference signal; and
receiving, by the first device from the second device, the relative position for the second device, the relative position for the second device being obtained by the second device by measuring the reference signal.

3. The method of claim 1, wherein obtaining the relative position for the second device comprises:
receiving, by the first device from the second device, a reference signal; and
obtaining, by measuring the reference signal at the first device, the relative position for the second device.

4. The method of claim 1, wherein obtaining the relative position for the second device comprises:
transmitting, by the first device, a sensing signal;
receiving a reflection of the sensing signal; and
processing the reflection of the sensing signal to obtain the relative position for the second device.

5. The method of claim 1, wherein obtaining the relative position for the second device comprises:
receiving, by the first device from the second device, the relative position for the second device, wherein the second device has obtained the relative position for the second device by:
transmitting, at the second device, a sensing signal;
receiving, at the second device, a reflection of the sensing signal; and
processing the reflection of the sensing signal, by the second device, to obtain the relative position for the second device.

6. The method of claim 5, further comprising:
receiving, by the first device from the second device, feedback, the feedback including an updated estimate for the relative position for the second device; and
transmitting, by the first device to the third device, the updated estimate for the relative position for the second device.

7. A method comprising:
receiving feedback from a device, the feedback including:
a position estimate; and
a position estimation mean squared error (MSE) associated with the position estimate;
adding, to a database of entries referencing a plurality of devices, an entry associated with the device; and
characterizing, in the database, the device as located in a given tier, the characterizing based on the position estimation MSE being greater than a first threshold associated with the given tier.

8. The method of claim 7, wherein the characterizing is further based on the position estimation MSE being less than a second threshold associated with the given tier.

9. The method of claim 7, further comprising selecting the first threshold for a particular use-case or for a particular application.

10. The method of claim 7, further comprising:
receiving, from the device, further feedback; and
updating the database to alter the entry associated with the device on the basis of the further feedback.

11. An apparatus of a first device, the apparatus comprising:
at least one processor; and
a non-transitory computer readable storage medium, coupled to the at least one processor, storing programming for execution by the at least one processor, the programming including instructions to cause the apparatus to:
obtain an absolute position for the first device associated with a first tier of devices, where the absolute position relates to a position in a global coordinate system;
obtain a relative position for a second device, the second device characterized as being part of a second tier of devices distinct from the first tier of devices, and the relative position for the second device being relative to the first device; and
transmit, to a third device, position information, wherein the position information enables the third device to obtain an estimate for the absolute position for the second device, the position information including:
an indication of an estimate for the absolute position for the first device; and
an indication of an estimate for the relative position for the second device.

12. The apparatus of claim 11, wherein the instructions to cause the apparatus to obtain the relative position for the second device comprise instructions to cause the apparatus to:
transmit a reference signal; and
receive, from the second device, the relative position for the second device, the relative position for the second device being obtained by the second device by measuring the reference signal.

13. The apparatus of claim 11, wherein the instructions to cause the apparatus to obtain the relative position for the second device comprise instructions to cause the apparatus to:
receive, from the second device, a reference signal; and
obtain, by measuring the reference signal, the relative position for the second device.

14. The apparatus of claim 11, wherein the instructions to cause the apparatus to obtain the relative position for the second device comprise instructions to cause the apparatus to:
transmit a sensing signal;
receive a reflection of the sensing signal; and
process the reflection of the sensing signal to obtain the relative position for the second device.

15. The apparatus of claim 11, wherein the instructions to cause the apparatus to obtain the relative position for the second device comprise instructions to cause the apparatus to:
receive, from the second device, the relative position for the second device;
wherein the second device has obtained the relative position for the second device by:
transmitting, at the second device, a sensing signal;
receiving, at the second device, a reflection of the sensing signal; and
processing, at the second device, the reflection of the sensing signal to obtain the relative position for the second device.

16. The apparatus of claim 15, wherein the programming includes further instructions to cause the apparatus to:
receive, from the second device, feedback, the feedback including an updated estimate for the relative position for the second device; and
transmit, to the third device, the updated estimate for the relative position for the second device.

17. An apparatus comprising:
at least one processor; and
a non-transitory computer readable storage medium, coupled to the at least one processor, storing programming for execution by the at least one processor, the programming including instructions to cause the apparatus to:
receive feedback from a device, the feedback including:
a position estimate; and
a position estimation mean squared error (MSE) associated with the position estimate;
add, to a database of entries referencing a plurality of devices, an entry associated with the device; and
characterize, in the database, the device as located in a given tier, the characterizing based on the position estimation MSE being greater than a first threshold associated with the given tier.

18. The apparatus of claim 17, wherein the instructions to cause the apparatus to characterize the device as located in the given tier comprise instructions to cause the apparatus to characterize the device as located in the given tier based on the position estimation MSE being less than a second threshold associated with the given tier.

19. The apparatus of claim 17, wherein the programming includes further instructions to cause the apparatus to select the first threshold for a particular use-case or for a particular application.

20. The apparatus of claim 17, wherein the programming includes further instructions to cause the apparatus to:
receive, from the device, further feedback; and
update the database to alter the entry associated with the device on the basis of the further feedback.
